(19) United States
(12) Patent Application Publication
(10) Pub. No.: US 2013/0336243 A1
(43) Pub. Date: Dec. 19, 2013

(54) Apparatus and Method for Control Packet Transmission Scheduling During Hybrid ARQ Processes

(71) Applicant: Broadcom Corporation, Irvine, CA (US)

(72) Inventors: Ozgur EKICI, Escondido, CA (US); Ahmed Arsalan, Carlsbad, CA (US)

(21) Appl. No.: 13/907,409

(22) Filed: May 31, 2013

Related U.S. Application Data
(60) Provisional application No. 61/661,655, filed on Jun. 19, 2012.

(51) Int. Cl. H04W 72/04

(52) U.S. Cl. CPC H04W 72/0406
USPC 370/329

(57) ABSTRACT

An apparatus and method is provided for efficiently transmitting control packets, signaling messages and/or data packets. A user equipment can effectively reserve at least one process to be used for transmission of signaling messages and/or data packets. In other words, the number of processes that are used for transmission of control packets is limited. Accordingly, not all the uplink tunnels will be clogged with control packets such that no or very little signaling messages and/or data packets can be transmitted.

### CROSS REFERENCE TO RELATED APPLICATIONS

The present application claims priority to U.S. Provisional Patent Application No, 61/661,655, filed on Jun. 19, 2012, which is hereby expressly incorporated by reference in its entirety.

### BACKGROUND

1. Field

The present invention relates generally to controlling packet transmission scheduling for Hybrid Automatic Repeat Request (hybrid ARQ or HARQ) processes.

2. Background Art

High Speed Uplink Packet Access (HSUPA) is a mobile technology protocol for the uplink of the High Speed Packet Access (HSPA), which offers, among other features, high data rate and faster round trip time for reduced latency. One of the main features of HSPUA is use of multiple HARQ processes.

During Enhanced Dedicated Channel (E-DCH) operation (i.e. also known as HSUPA), frequent transmission and re-transmission of control packets on multiple HARQ processes on the uplink can reduce the data throughput or even block the transmission of time critical radio resource control (RRC) signaling messages such as measurementReport and activeSetUpdateComplete; potentially causing call drops. Control packets (such as, but not limited to, scheduling information) can be sent on any HARQ process as frequent as every transmission time interval. The transmitted control packets have to be acknowledged by radio link set containing the serving cell. The re-transmission of such control packets can continue, for example, for 8 transmission time interval in a row spanning, for example, 320 ms for a Transmission Time Interval (TTI) of 10 ms (or 128 ms for 2 ms TTI) per scheduling information transmission attempt. In practical network configurations, multiple HARQ processes can be busy trying to transmit/re-transmit control only packets; putting radio link stability in danger as well as reducing uplink throughput.

### BRIEF DESCRIPTION OF THE DRAWINGS/FIGURES

The accompanying drawings, which are incorporated herein and form part of the specification, illustrate the present disclosure and, together with the description, further serve to explain the principles of the disclosure and to enable a person skilled in the relevant art(s) to make and use the disclosure.

FIG. 1 illustrates a system, in accordance with an embodiment of the present disclosure.

FIG. 2A illustrates transmission time intervals, in accordance with a conventional system.

FIGS. 2B and 2C illustrate experiment results, in accordance with the conventional system of FIG. 2A.

FIGS. 3 illustrates transmission time intervals, in accordance with an embodiment of the present disclosure.

FIG. 4 is a flowchart illustrating a method, in accordance with an embodiment of the present disclosure.

FIG. 5 illustrates a computer system that can be utilized to implement one or more embodiments of the present disclosure.

The present disclosure will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### Overview

Apparatuses and methods are provided to efficiently transmit control packets, signaling messages and/or data packets. According to a first embodiment of the disclosure, an apparatus is provided that includes a radio transceiver and a control logic. The radio transceiver is configured to transmit signals to a network device. The control logic, which includes a plurality of processes, is configured to reserve at least one of the plurality of processes for transmission of at least one of signaling messages and data packets.

According to another embodiment of the disclosure, there is provided a method for reserving at least one of a plurality of processes for transmission of at least one of signaling messages and data packets. The method further includes determining a process corresponding to a current time interval and determining whether the determined process is the reserved process.

Another embodiment includes an article of manufacture including a computer-readable storage medium having instructions stored thereon, execution of which by a computing device causes the computing device to perform operations including reserving at least one of a plurality of processes for transmission of at least one of signaling messages and data packets. The operations further include determining a process corresponding to a current time interval and determining whether the determined process is the reserved process.

### Detailed Discussion

The following detailed description of the present disclosure refers to the accompanying drawings that illustrate exemplary embodiments consistent with this disclosure. Other embodiments are possible, and modifications can be made to the embodiments within the spirit and scope of the present disclosure. Therefore, the detailed description is not meant to limit the present disclosure. Further, the scope of the present invention is defined by the appended claims

It would be apparent to one of skill in the art that aspects of the present disclosure, as described below, can be implemented in many different embodiments of software, hardware, firmware, and/or the entities illustrated in the figures. Any actual software code with the specialized control of hardware to implement the present disclosure is not limiting of the present disclosure. Thus, the operational behavior of the present disclosure will be described with the understanding that modifications and variations of the embodiments are possible, given the level of detail presented herein.

This specification discloses one or more embodiments that incorporate the features of this disclosure. The disclosed embodiment(s) merely exemplify the disclosure. The scope of the disclosure is not limited to the disclosed embodiment(s). Further, the invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Moreover, terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B.” “evolved Node B (eNode B),” home Node B (HNB),” “home access point (HAP),” or the like, are utilized interchangeably in the subject specification and drawings, and refer to a wireless network component or apparatus that serves and receives data, control, voice, video, sound, gaming, or substantially any data-stream or signaling-stream from a set of subscriber stations. It is noted that in the subject specification and drawing, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Reference to modules in this specification and the claims means any combination of hardware or software components for performing the indicated function. A module need not be a rigidly defined entity, such that several modules may overlap hardware and software components in functionality. For example, a software module may refer to a single line of code within a procedure, the procedure itself being a separate software module. One skilled in the relevant arts will understand that the functionality of modules may be defined in accordance with a number of stylistic or performance-optimizing techniques, for example.

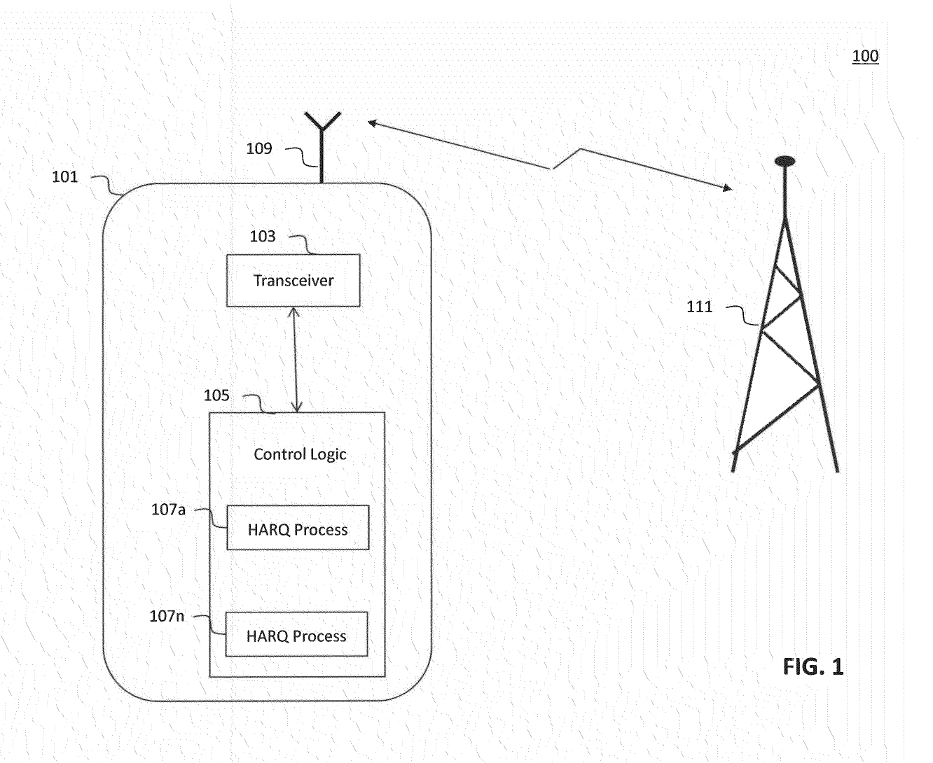

FIG. 1 illustrates a system 100, according to an embodiment of the present disclosure. For example, system 100 illustrates user equipment (UE) 101 that communicates with wireless network device 111 such as a Node B, a base station, or the like. According to one example, system 100 employs E-DCH as its protocol for the uplink communication (e.g., the link from UE 101 to network device 111.) During the E-DCH operation, UE 101 transmits control packets (such as, but not limited to, scheduling information), signaling messages (such as, but no limited to, messages such as measurementReport and activeSetUpdateComplete), and/or data packets on the uplink to the wireless network device 111. For the control packets, network device 111 sends positive or negative acknowledgments to UE 101 depending on whether network device 111 correctly or incorrectly receives the control packets. The acknowledgments are sent on a downlink (e.g., the link from network device 111 to UE 101.)

In one example, UE 101 can be, but is not limited to, a mobile phone, smartphone, personal digital assistant (PDA), etc., and can include, but is not limited to, a transceiver 103 including a radio transmitter and receiver, a control logic 105 (such as, but not limited to a Hybrid Automatic Repeat Request (HARQ) entity), and an antenna 109, in addition to other modules, all of which can be executed utilizing one or more processors. For example, the control logic 105 can be implemented using one or more processor(s) and/or state machine logic, or a combination thereof, programmed or implemented to have the functionality described herein.

According to one example, UE 101 is configured to use transceiver 103 and antenna 109 for communication with network device 111. For example, mobile device 101 transmits control packets, signaling messages, and/or data packets to network device 111 and receives acknowledgments, signaling messages, and/or data packets from device 111 through transceiver 103 and antenna 109.

According to one embodiment, control logic 105 includes a number of parallel HARQ processes 107a-107n, which support control logic 105, allowing transmissions to take place continuously while waiting for the feedback of previous transmissions. Each HARQ process 107a-107n can be considered as uplink data tunnel for UE 101. Control logic 105 is configured to identify the HARQ process for which a transmission should take place and control logic 105 is also configured to route the received feedback to the appropriate HARQ process. According to one example, the number of HARQ 107a-107n can depend on Transmission Time Interval (TTI) of the E-DCH operation. For example, E-DCH operation with TTI of 10 ms allows four (4) parallel HARQ processes Whereas operation with 2 ms TTI allows eight (8) parallel HARQ processes for uplink connection. However, this invention is not limited to these numbers of HARQ processes.

According to one exemplary embodiment, HARQ processes 107a-107n are configured to facilitate transmission of control packets, signaling messages, and/or data packets. According to this example, each TTI can correspond to a HARQ process, e.g., HARQ process 107a. HARQ process 107a uses its corresponding TTI to transmit a control packet that is in its corresponding buffer (not shown) After the control packet is transmitted, control logic 105 receives a feedback from, for example, network device 111, whether the transmission of the control packet was successful. If the transmission is not successful, HARQ process 107a uses its next corresponding TTI to re-transmit the control packet. in one example, the re-transmission of the control packet of HARQ process 107a can continue for a limited number of times.

However, if the transmission of the control packet was successful, HARQ 107a uses its next corresponding TTI to transmit another control packet in its buffer. if no control packet is available, HARQ 107a can transmit any available signaling message and/or data packet.

Conventionally, all of the HARQ processes were able to transmit control packets. Accordingly, if all of the HARQ processes were busy with transmission and/or re-transmission of control packets, then control packet transmission would clog all uplink tunnels (HARQ processes) blocking transmission of any other signaling messages and/or data packets. This occurred because of the conventional technique of re-transmitting control packets on the next corresponding TTI until an ACK is received from the network device.

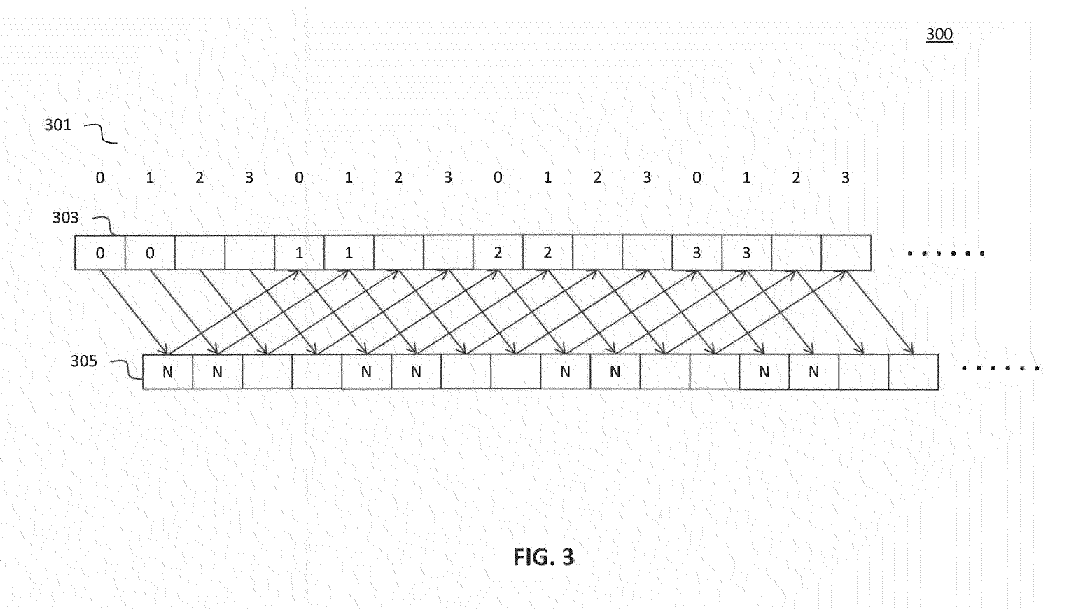

According to one embodiment of this invention, the number of HARQ processes that can be used to transmit control packets is limited. As to be discussed in more detail with respect to FIG. 3, the maximum number of HARQ processes used for simultaneous transmission of control packets can be limited to N per uplink connection. As an example, N can be two (2) for TTI10 operation while it can be assigned as four (4) for TTI2 operation; where the rest of the HARQ processes are made available to be used for transmission of signaling messages and/or data packets. This disclosure is not limited to these numbers of HARQ processes mentioned herein, as other numbers could be selected by those skilled in the arts based on the discussion herein.

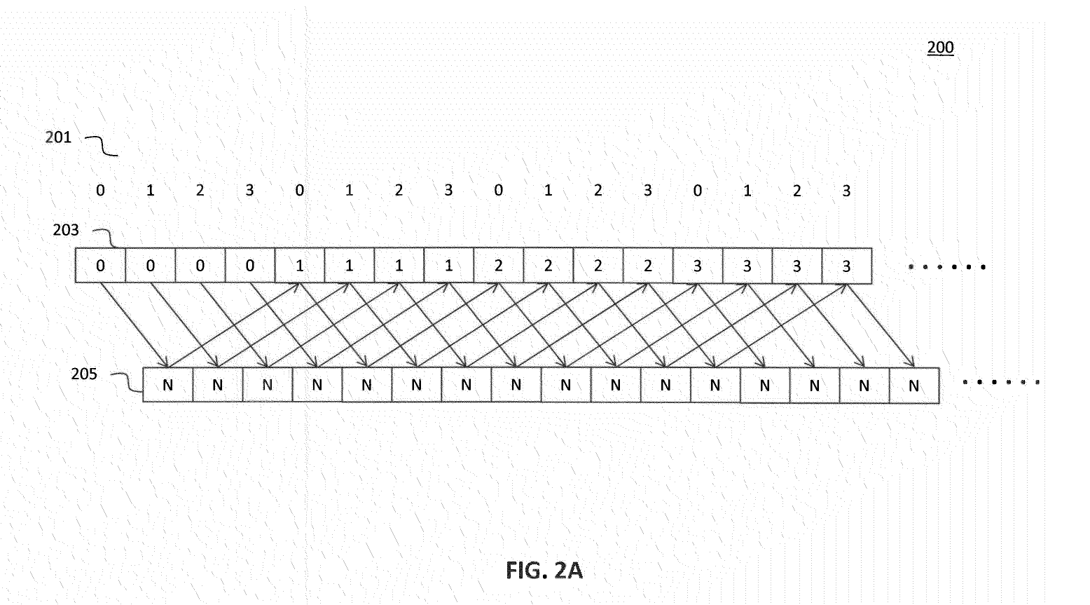

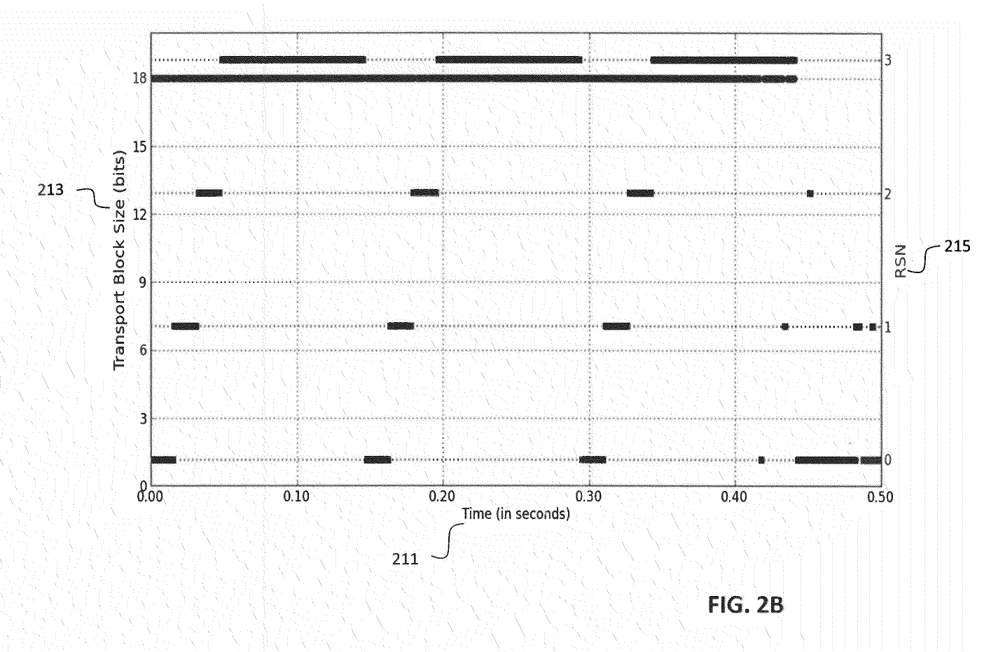

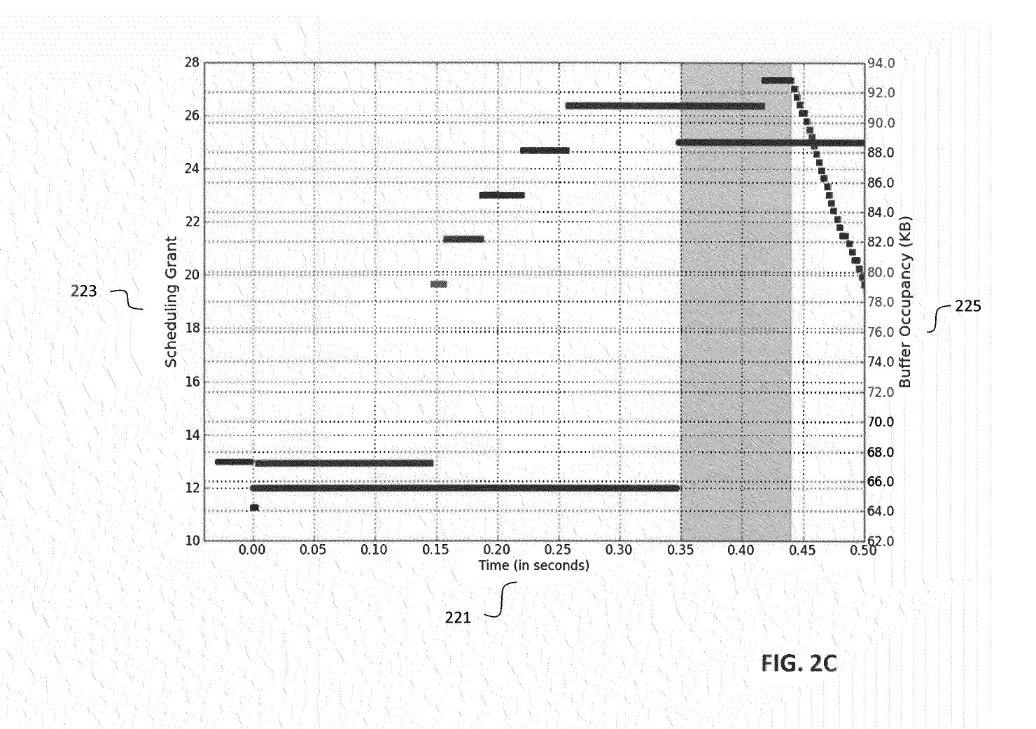

FIG. 2A illustrates a conventional scenario where all HARQ processes 107a-107n are busy with re-transmission attempts. HARQ processes identifications (IDs) are illustrated by 201. In this example, four (4) HARQ processes, for example, 107a, 107b, 107c, and 107d, with identification numbers 0, 1, 2, and 3, respectively, are used in control logic for transmission of control packets, signal messaging, and/or data packets. According to this conventional example, all four (4) HARQ processes can transmit control packets.

FIG. 2A further illustrates time slots 203 used by HARQ processes for transmission to, for example, network device 111, with Retransmission Sequence Number (RSN) information. The RSN information indicates whether the transmission is an “initial transmission” (RSN=0), or “re-transmission” (RSN>0) and also the number of re-transmission attempts. In this conventional example, 205 is the feedback from network device 111. In this example, HARQ processes with IDs 0-3 initially transmit their control packets (RSN=0). Feedback 205 notifies HARQ processes that their transmission was unsuccessful. Therefore, HARQ processes re-transmit their control packets (RSN=1), which are negatively acknowledged. These HARQ processes can continue their re-transmission of their control packet until they are successfully transmitted and/or a maximum number of re-transmissions is reached. As shown in FIG. 2A all the HARQ processes are busy with packet re-transmission attempts, namely all of the HARQ processes are used to re-transmit the old data. This re-transmission of the old data is clogging the data tunnels.

FIG. 2B further illustrates conventional re-transmission clogging of data tunnels in an experiment with a live network. As illustrated in FIG. 2B, multiple HARQ processes can be busy trying to transmit/re-transmit control packets, which means that these processes cannot be used for transmission of any signaling message and/or data packet, thereby putting radio link stability in danger as well as reducing uplink throughput. The X axis 211 represents time in seconds. The Y axis 213 represents the transport block size of packets transmitted in bits. In this experiment the transport block size of the packets transmitted is constant at 18 bits (the size of control packets) for almost 0.45 seconds. Therefore, FIG. 2B illustrates that only control packets are transmitted/re-transmitted for this period of time and no signaling messages and/or data packets is being transmitted, illustrating that the data tunnels are congested with only control packets.

Similarly, Y axis 215 illustrates Retransmission Sequence Number (RSN) of uplink transmission. In this example a conventional configuration with eight (8) HARQ processes for TTI 2 ms configuration is used. As illustrated in FIG. 2B, for the first 0.45 seconds, all the HARQ processes are busy transmitting (RSN=0) or re-transmitting (RSN=1 or 2 or 3) control packets. As a result of this clogging, UE 101 would not be able to send any signaling messages and/or data packets on the uplink almost for half a second.

FIG. 2C illustrates the effects of conventional control packet re-transmission on the uplink tunnel, according to the same experiment. The X axis 221 illustrates time in seconds and the Y axis 223 illustrates the scheduling grant, which indirectly indicates the uplink data rate at which UE 101 can transmit. Also, the Y axis 225 represents the buffer capacity of UE 101 for buffering data packets for transmission. In this experiment, for the first 0.35 seconds of the operation, the scheduling grant is at 13 or 12 and the buffer occupancy increases from 64 KB to 91 KB, illustrating that the uplink tunnels are clogged with control packets and no or very little data packets are being transmitted. After the 0.35 seconds mark, the scheduling grant increases to 25, a high serving grant (e.g., permission to transmit with high data rate) to UE 101. However, UE 101 cannot transmit data packets immediately on the uplink because all the uplink HARQ processes are occupied with control data re-transmission. FIG. 2C further illustrates that after around the 0.45 seconds mark, the buffer occupancy decreases as more data packets are transmitted on the uplink.

FIG. 3 illustrates a scenario according to an exemplary embodiment where at least one of the HARQ processes 107a-107n is reserved or allocated for transmission of signaling messages and/or data packets. In the example of FIG. 3, a TTI 10 ms configuration is illustrated where the total number of available HARQ processes is four (4). This is for illustrative purposes only and other TTI configurations and/or number of HARQ processes can be used.

HARQ processes identifications (IDs) are illustrated by 301. In this example, four (4) HARQ processes, for example, 107a, 107b, 107c, and 107d, with identification numbers 0, 1, 2, and 3, respectively, are used in control logic 105. According to this exemplary embodiment, HARQ processes with IDs 0 and 1 can transmit control packets, signaling messages, and/or data packets. In addition, HARQ processes with IDs 2 and 3 are reserved only for transmission of signaling messages and/or data packets. Therefore, according to this example, HARQ processes with IDs 2 and 3 will not be used to transmit any control packets. This is for illustrative purposes only and any other number of HARQ processes can be reserved for transmission of signaling messages and/or data packets, as long as at least one HARQ process is reserved for transmission of signaling messages and/or data packets, and therefore not used for the transmission of data packets.

FIG. 3 farther illustrates time slots 303 used by HARQ processes for transmission to, for example, network device 111, with Retransmission Sequence Number (RSN) information. The RSN information indicates whether the transmission is an “initial transmission” (RSN=0), or “re-transmission” (RSN>0); also the number of re-transmission attempts. In this example, 305 is the feedback from network device 111. In this example, HARQ processes with IDs 0 and 1 initially transmit their control packets (RSN=0). Feedback 305 notifies HARQ processes with IDs 0 and 1 that their transmission was unsuccessful. Therefore, HARQ processes re-transmit their control packets (RSN=1), which are negatively acknowledged. These HARQ processes can continue their re-transmission of their control packet until they are successfully transmitted or a maximum number of re-transmissions is reached (RSN>3, as shown). As shown in FIG. 3 only two (2) out of four (4) HARQ processes are busy with control packet re-transmission attempts and the other two (2) HARQ processes can be used for transmitting signaling messages and/or data packets. Specifically, HARQ processes with IDs 2 and 3 are available for non-control packet transmissions.

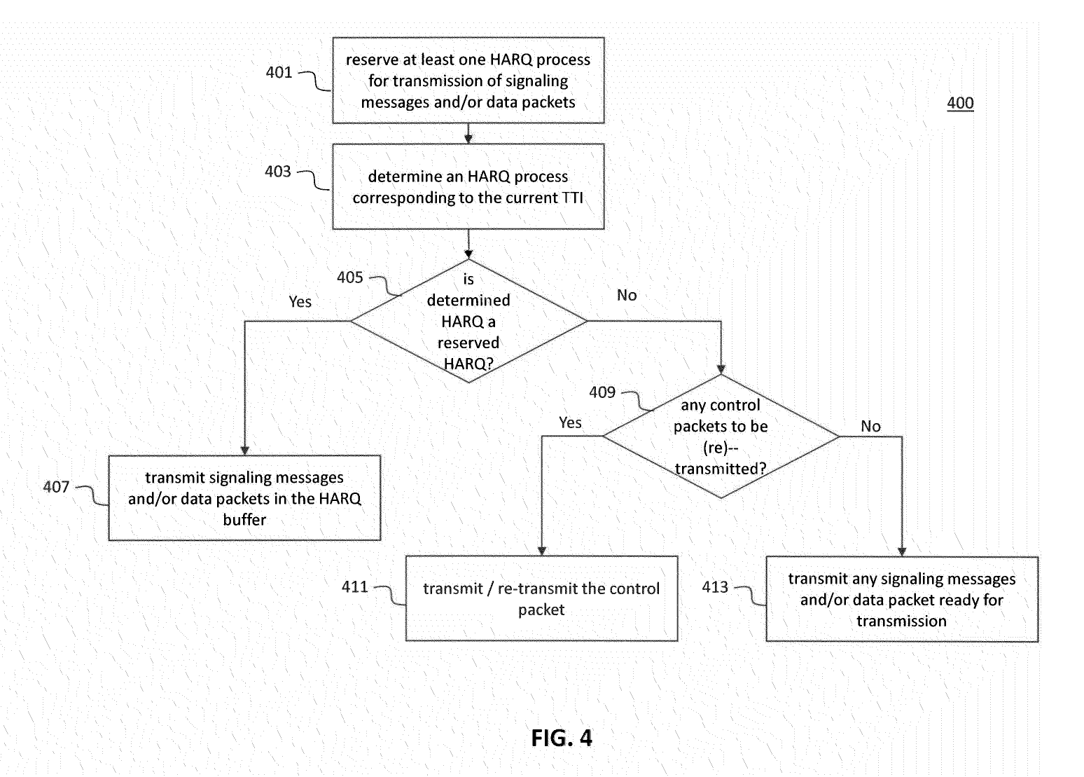

FIG. 4 is a flowchart depicting a method 400, according to an embodiment of the present disclosure. For example, method 400 can be performed by UE 101 and more specifically by control logic 105. It is to be appreciated not all steps may be needed to perform disclosure provided herein. Further, some of the steps may be performed simultaneously, or in a different order than that shown in FIG. 4, as will be understood by those skilled in the art. Reference is made to system 100 in FIG. 1 merely for convenience of discussion. Other systems may be used to perform the method as will be understood by those skilled in the arts.

In step 401, control logic 105 reserves at least one HARQ process out of a plurality of HARQ processes 107a-107n for transmitting only signaling messages and/or data packets. In other words, the number of HARQ processes used for transmission of control packets is limited, so that at least one HARQ process out of the plurality of HARQ processes is available for non-control packet transmission.

In step 403, control logic 105 determines the HARQ process that corresponds to the current TTI. In step 405, control logic 105 determines whether the HARQ process, which corresponds to the current TTI, is a process reserved for signaling messages and/or data packets (i.e. a non-control packet transmission).

If the HARQ process is a reserved process, in step 407 a signaling message and/or data packet stored its buffer is transmitted, assuming there is one or more in its buffer. If the HARQ process is not a reserved process, in step 409, control logic 105 determines whether the HARQ process has control packets or other packets to transmit.

In step 411, a control packet is transmitted or re-transmitted if there are control packets in the HARQ process' buffer. Otherwise, a signaling message or data packet is transmitted in step 413, assuming there are one or more in the corresponding transmit buffer.

The present disclosure has been described in terms of HARQ processes operating in a wireless communications network. However, the disclosure is not so limited, as will be understood by those skilled in the arts. The present disclosure can apply to any communications network (wireless or otherwise) having a protocol that utilizes re-transmissions and multiple communications tunnels or paths between a sender and a receiver, where the re-transmissions are capable of dominating network resources and bandwidth without the mitigation described herein.

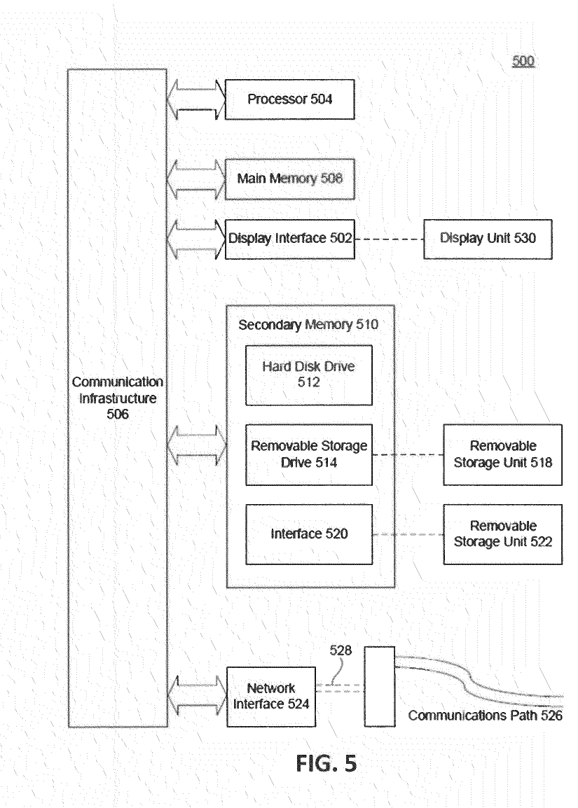

Various aspects of the present disclosure can be implemented by software, firmware, hardware, or a combination thereof. FIG. 5 illustrates an example computer system 500 in which the present disclosure, or portions thereof, can be implemented as computer-readable code. For example, control logic 105, HARQ processes 107a-107n, and/or the method 400 can he implemented by computer system 500. Various embodiments of the disclosure are described in terms of this example computer system 500. After reading this description, it will become apparent to a person skilled in the relevant art how to implement the disclosure using other computer systems and/or computer architectures.

Computer system 500 includes one or more processors, such as processor 504. Processor 504 can be a special purpose or a general purpose processor. Processor 504 is connected to a communication infrastructure 506 (for example, a bus or network).

Computer system 500 also includes a main memory 508, preferably random access memory (RAM), and may also include a secondary memory 510. Secondary memory 510 may include, for example, a hard disk drive 512, a removable storage drive 514, and/or a memory stick. Removable storage drive 514 may comprise a floppy disk drive, a magnetic tape drive, an optical disk drive, a flash memory, or the like. The removable storage drive 514 reads from and/or writes to a removable storage unit 518 in a well-known manner. Removable storage unit 518 may comprise a floppy disk, magnetic tape, optical disk, etc. that is read by and written to by removable storage drive 514. As will be appreciated by persons skilled in the relevant art(s), removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 that allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 are in the form of signals that may be electronic, electromagnetic, optical, or other signals capable of being received by communications interface 524. These signals are provided to communications interface 524 via a communications path 526. Communications path 526 carries signals and may be implemented using wire or cable, fiber optics, a phone line, a cellular phone link, an RF link or other communications channels,

In this document, the terms “computer program medium” and “computer usable medium” are used to generally refer to media such as removable storage unit 518, removable storage unit 522, and a hard disk installed in hard disk drive 512. Signals carried over communications path 526 can also embody the logic described herein. Computer program medium and computer usable medium. can also refer to memories, such as main memory 508 and secondary memory 510, which can be memory semiconductors (e.g. DRAMs, etc.). These computer program products are means for providing software to computer system 500.

Computer programs (also called computer control logic) are stored in main memory 508 and/or secondary memory 510. Computer programs may also be received via communications interface 524. Such computer programs, when executed, enable computer system 500 to implement the present disclosure as discussed herein, In particular, the computer programs, when executed, enable processor 504 to implement the processes of the present disclosure. Accordingly, such computer programs represent controllers of the computer system 500. Where the disclosure is implemented using software, the software may be stored in a computer program product and loaded into computer system 500 using removable storage drive 514, interface 520, hard drive 512 or communications interface 524.

The disclosure is also directed to computer program products comprising software stored on any computer useable medium. Such software, when executed in one or more data processing device, causes a data processing device(s) to operate as described herein. Embodiments of the disclosure employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The exemplary embodiments described herein are provided for illustrative purposes, and are not limiting. Other exemplary embodiments are possible, and modifications may be made to the exemplary embodiments within the spirit and scope of the disclosure.

It is to be appreciated that the Detailed Description section, and not the Abstract section, is intended to be used to interpret the claims. The Abstract section may set forth one or more, but not all exemplary embodiments, of the disclosure, and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus the disclosure should not be limited by any of the above-described exemplary embodiments, Further, the claims should be defined only in accordance with the following claims and their equivalents.

What is claimed is:

1. An apparatus, comprising:
a radio transceiver configured to transmit signals to a network device; and
a control logic comprising a plurality of processes and configured to reserve at least one of the plurality of processes for transmission of at least one of signaling messages and data packets.

2. The apparatus of claim 1, wherein the control logic is further configured to:
determine a process corresponding to a current time interval; and
determine whether the determined process is the reserved process.

3. The apparatus of claim 2, wherein the control logic is further configured to cause transmission of a signaling message or a data packet associated with the reserved process if the determined process is the reserved process.

4. The apparatus of claim 2, wherein the control logic is further configured to determine whether any control packets associated with the determined process are to be transmitted if the determined process is not the reserved process.

5. The apparatus of claim 4, wherein the control logic is further configured to cause transmission of a signaling message or a data packet if no control packets associated with the determined process are to be transmitted.

6. The apparatus of claim 1, wherein:
the radio transceiver is further configured to receive feedback information from the network device; and
the control logic is further configured to determine a process corresponding to the feedback information and to route the feedback information to the corresponding process.

7. The apparatus of claim 1, wherein the plurality of processes includes four processes, wherein at least one of the four processes is reserved for transmission of the at least one of signaling messages and data packets.

8. The apparatus of claim 1, wherein the plurality of processes includes eight processes, wherein at least one of the eight processes is reserved for transmission of the at least one of signaling messages and data packets.

9. A method, comprising:
reserving at least one of a plurality of processes for transmission of at least one of signaling messages and data packets;
determining a process corresponding to a current time interval; and
determining whether the determined process is the reserved process.

10. The method of claim 9, further comprising:
causing transmission of a signaling message or a data packet associated with the reserved process if the determined process is the reserved process.

11. The method of claim 9, farther comprising:
determining whether any control packets associated with the determined process are to be transmitted if the determined process is not the reserved process.

12. The method of claim 9, further comprising:
receiving feedback information from a network device; and
determining a process corresponding to the feedback information and routing the feedback information to the corresponding process.

13. The method of claim 9, wherein the plurality of processes includes four processes, at least one of the four processes is reserved for transmission of the at least one of signaling messages and data packets.

14. The method of claim 9, wherein the plurality of processes includes eight processes, at least one of the eight processes is reserved for transmission of the at least one of signaling messages and data packets,

15. An article of manufacture including a computer-readable storage medium having instructions stored thereon, execution of which by a computing device causes the computing device to perform operations comprising:
reserving at least one of a plurality of processes for transmission of at least one of signaling messages and data packets;
determining a process corresponding to a current time interval; and
determining whether the determined process is the reserved process.

16. The article of manufacture of claim 15, wherein the operations further comprise:
causing transmission of a signaling message or a data packet associated with the reserved process if the determined process is the reserved process.

17. The article of manufacture of claim 15, wherein the operations further comprise:
determining whether any control packets associated with the determined process are to be transmitted if the determined process is not the reserved process.

18. The article of manufacture of claim 15, wherein the operations further comprise:
receiving feedback information from a network device; and
determining a process corresponding to the feedback information and routing the feedback information to the corresponding process.

19. The article of manufacture of claim 15, wherein the plurality of processes includes four processes, at least one of the four processes is reserved for transmission of the at least one of signaling messages and data packets.

20. The article of manufacture of claim 15, wherein the plurality of processes includes eight processes, at least one of the eight processes is reserved for transmission of the at least one of signaling messages and data packets.
